(19) United States
(12) Patent Application Publication
(10) Pub. No.: US 2007/0267129 A1
(43) Pub. Date: Nov. 22, 2007

(54) Anti-block texturing of a thermoplastic adhesive coated core material

(76) Inventor: Lee David Graczyk, La Center, WA (US)

Correspondence Address: LEE D. GRACZYK, 34901 NE SCHULTZ RD., LA CENTER, WA, 98629, US

(21) Appl. No.: 11/699,058

(22) Filed: Jan. 29, 2007

Related U.S. Application Data
(60) Provisional application No. 60/764,647, filed on Feb. 3, 2006.

(51) Int. Cl. B32B 33/00

(52) U.S. Cl. 156/209

(57) ABSTRACT

A method for applying an anti-block texture in the surface of a thermoplastic adhesive coated core material as it is applied, or directly after it is applied, to a moving substrate for the sole purpose of reducing the surface area that comes into contact with the opposite side of the substrate in the sheet stack and thus reducing the blocking characteristics.

### CROSS REFERENCE TO RELATED APPLICATIONS

I hereby claim the benefits of the following provisional patent applications;

U.S. Patent Application #60/762,985 Jan. 26, 2006

U.S. Patent Application #60/764,647 Feb. 3, 2006

### BACKGROUND OF THE INVENTION

Thermoplastic adhesive coated core materials, such as strings and tapes, are applied to a large number of different substrates to add reinforcement and/or to be later used as opening devices (tear tapes). These thermoplastic adhesive coated core materials are applied directly to the substrate, as it moves in web form, with a heated applicator, at production speeds that are sometimes higher than 500 feet per minute. Two types of applicators are commonly used to melt and apply the thermoplastic adhesive coated core materials onto the substrate. One is a heated wheel that is held against the surface of the substrate and is driven by the movement of the web. The thermoplastic adhesive coated core material is guided into and pulled against the heated peripheral surface of the wheel by this movement. The other type is a heated tube that uses a shoe to press the thermoplastic adhesive coated core material onto the surface of the substrate. Movement of the substrate pulls the thermoplastic adhesive coated core material through the applicator. An optional cooling apparatus is sometimes used to further compress the thermoplastic adhesive coated core material onto the substrate. The peripheral surface of both the optional cooling wheel and the hot wheel applicator are smooth, thus, producing a smooth, flat surface in the applied thermoplastic adhesive coated core material. For the purposes of this invention, and as used herein, the term “convention applicator” with include either type of these two applicators.

The thermoplastic adhesive coated core materials, such as strings and tapes, are designed to adhere to the substrate and set-up by cooling before the moving web is cut and stacked as sheets. The problem of the thermoplastic adhesive coated core material blocking with the opposite side of the substrate can occur in the sheet stack if the line speed is too fast and/or if the thermoplastic adhesive does not set up in time. And, in some cases, when the substrate is laminated with special films, blocking can result even when the thermoplastic adhesive coated core material is cooled to well below the flow point temperature before reaching the sheet stack.

| | |
|---|---|
| U.S. Pat. No. 6,368,449 | Apr. 9, 2002 |
| U.S. Pat. No. 5,411,625 | May 2, 1995 |
| U.S. Pat. No. 4,955,433 | Sep. 11, 1990 |
| U.S. Pat. No. 4,285,758 | Aug. 25, 1981 |
| U.S. Pat. No. 5,662,767 | Sep. 2, 1997 |
| U.S. Pat. No. 4,394,206 | Jul. 19, 1983 |

### BRIEF SUMMARY OF THE INVENTION

This invention, of applying an anti-block texture to the surface of the thermoplastic adhesive coated core material, during the application or directly after, will help reduce the blocking problem in the sheet stack by reducing the amount of surface area in the thermoplastic adhesive coated core material that comes into contact with the opposite side of the substrate in the sheet stack. This will reduce the amount of labor necessary prepping the sheet stacks for secondary processing.

### BRIEF DESCRIPTION OF THE DRAWINGS

FIG. 1 shows a process diagram of a thermoplastic adhesive coated core material being applied to a substrate with an anti-block texturing hot wheel applicator.

FIG. 2 is a detailed view of FIG. 1 showing the anti-block texturing being applied on the surface of the thermoplastic adhesive coated core material as it is applied with an anti-block texturing hot wheel applicator

FIG. 3 shows an exploded view of an anti-block texturing hot wheel applicator.

FIG. 4 shows how the applicators are mounted and how the position of each applicator can be adjusted for proper positioning of the thermoplastic coated core material across the web.

FIG. 5 shows a process diagram of a chilled anti-block texturing wheel applying an anti-block texture to the surface of a thermoplastic adhesive coated core material after it has been applied to a substrate with a conventional applicator.

FIG. 6 is a detailed view of FIG. 5 showing the anti-block texturing being applied on the surface of the thermoplastic adhesive coated core material by a chilled anti-block texturing wheel.

FIG. 7 shows an exploded view of a chilled anti-block texturing wheel.

FIG. 8 shows a sectional view of a chilled anti-block texturing wheel.

FIG. 9 shows the chilled anti-block texturing wheels mounted and how the position of each wheel can be adjusted for proper positioning over the thermoplastic adhesive coated core material.

FIG. 10 shows a 3-dimensional view of the anti-block texturing in the surface of the thermoplastic adhesive coated core material.

FIG. 11 is a detailed view of FIG. 1 and FIG. 5 showing the effect of the anti-block texturing in the sheet stack.

### DETAILED DESCRIPTION OF A PREFERRED EMBODIMENT OF THE INVENTION

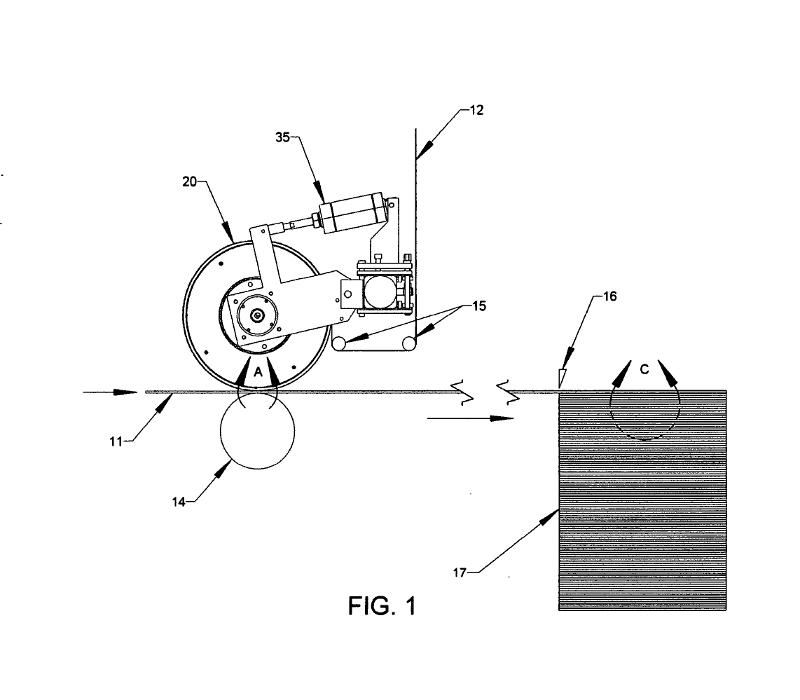

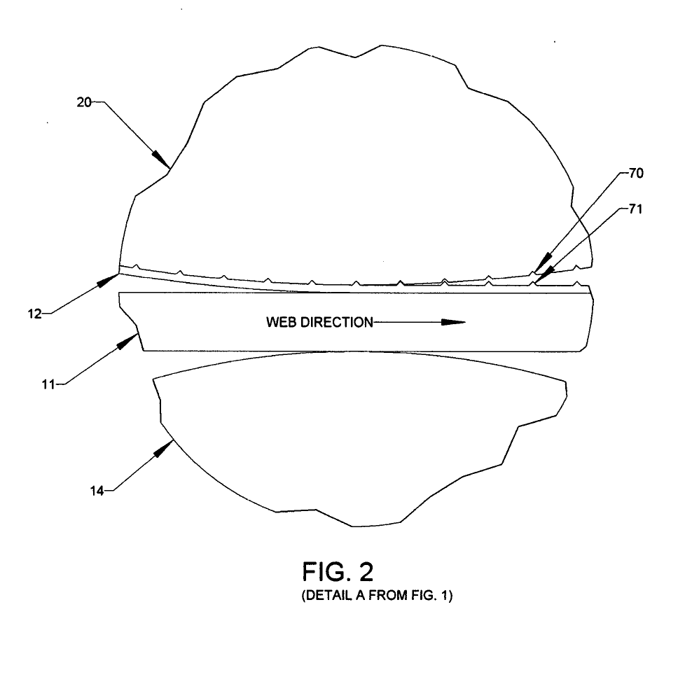

FIG. 1 shows the substrate 11 moving in web form from left to right. As the substrate 11 moves, the anti-block texturing hot wheel applicator 20 rotates counter clockwise and pulls the thermoplastic adhesive coated core material 12 from a dispenser (not shown). Two guide rolls 15 are used to bring the thermoplastic adhesive coated core material 12 into contact with the heated peripheral surface of the applicator wheel 20. The thermoplastic adhesive coated core material 12 is designed to attain the flow point temperature by the time the applicator wheel rotates the thermoplastic adhesive coated core material 12 into contact with the relatively cool substrate 11. Pressure is applied to the point of contact with the use of an air cylinder 35 and a nip roll 14 to bond the thermoplastic adhesive coated core material 12 onto the substrate 11. The anti-block texturing 70 (FIG. 2) on the peripheral surface of the anti-block texturing hot wheel applicator 20 (FIG. 2) is formed into the surface of the thermoplastic adhesive coated core material 12 (FIG. 2). As the substrate 11 continues to move along its process, the thermoplastic adhesive coated string or tape cools and solidifies before reaching the knife 16. The knife 16, usually in the form of a rotary cutter, cuts the web into sheets where they are stacked at the end of the process in a sheet stack 17.

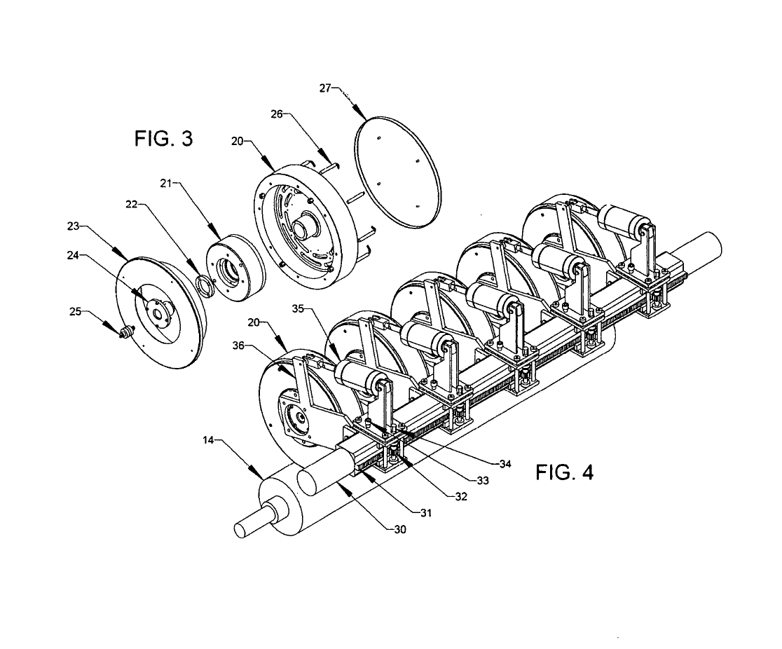

An exploded view of the anti-block hot wheel applicator is shown in FIG. 3. The anti-block hot wheel applicator consists of a wheel 20 with a substantially cylindrical outer surface, a side wall and a shaft concentric to the outer surface. Holes in the rim of the wheel 20 that are parallel to the axis of the wheel are fitted with heaters 26 and a temperature sensor (not shown). A slip ring 25 is used to make the electrical connections to the heaters 26 and temperature sensor allowing the wheel to rotate. The shaft of the wheel 20 is supported by the inner race of ball bearings. The outer races of the ball bearings are supported in the bearing housing 21. The wheel 20 and the ball bearings are held in place by the bearing retainer 22. The bearing housing 21 is fixed and has mounting holes for securing it to a mounting bracket 36 (FIG. 4). The bearing housing 21 contains a coolant passage and an inlet and outlet to provide cooling to the outer races of the ball bearings. The slip ring 25 is mounted in a slip ring support 24. The slip ring support 24 is attached to the bearing housing 21. Heat shields 23 & 27 are used to help reduce the amount of heat radiated to the surroundings. FIG. 4 shows the anti-block hot wheel applicators 20 attached to mounting brackets 36. Each mounting bracket 36 is mounted to a secondary rail bracket that can be moved a long a mounting beam 30. The mounting bracket 36 pivots about a pin on the secondary bracket. An air cylinder 35 lifts the anti-block hot wheel applicator 20 away from the nip roller 14 and also provides the necessary pressure to apply the thermoplastic adhesive coated core material to the substrate. The anti-block hot wheel applicators 20 are positioned over the web where it is desired to apply the thermoplastic adhesive coated core material. This adjustment is made my turning an adjustment bolt 34 which turns a gear 32. The gear 32 is engaged to fixed gear rack 31. A clamping bolt 33 secures the position of the applicator once the desired position is achieved.

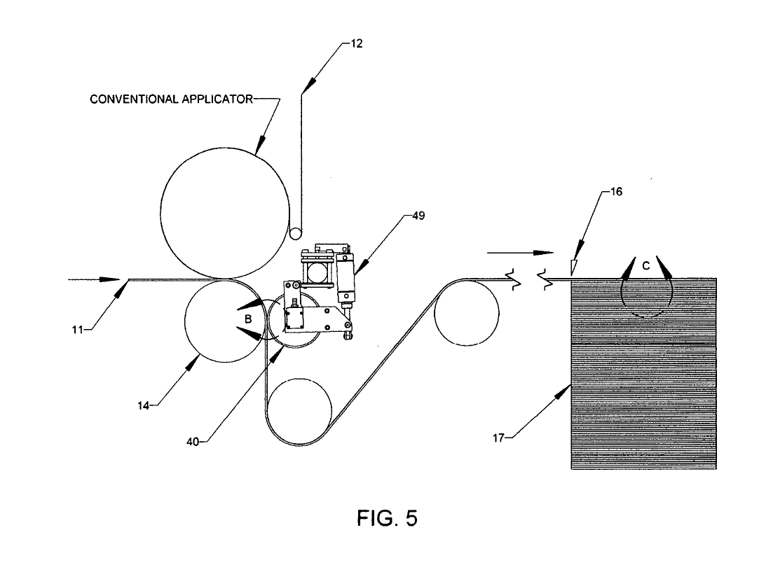

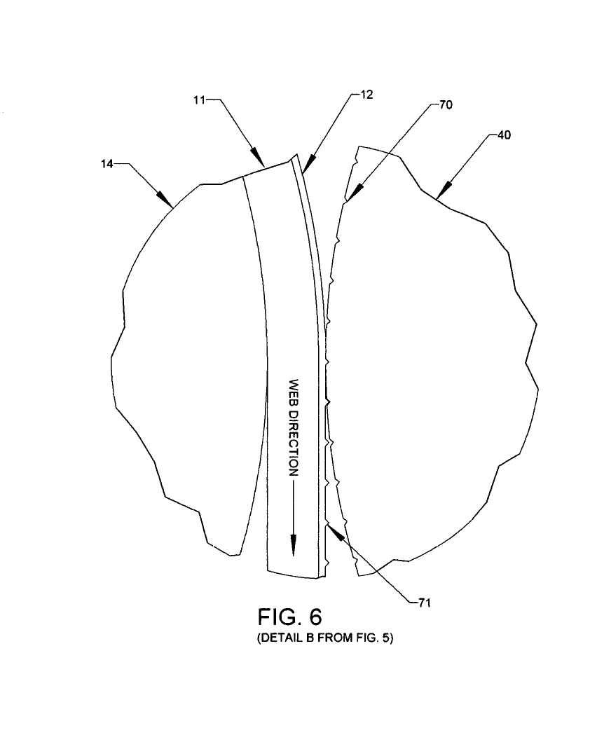

FIG. 5 shows a different method of applying the anti-block texturing than shown in FIG. 1. The process shown in FIG. 5 uses a chilled anti-block texturing wheel 40 down stream of a conventional applicator. The conventional applicator applies the thermoplastic adhesive coated core material 12 to the substrate 11. The surface of the thermoplastic adhesive coated core material 12 leaving the conventional applicator is smooth and still above the flow point temperature when it reaches the chilled anti-block texturing wheel 40. The anti-block texturing 70 (FIG. 6) on the peripheral surface of the chilled anti-block texturing wheel 40 (FIG. 6) is formed into the surface of the thermoplastic adhesive coated core material 12. Pressure is used, by use of an air cylinder 49 and a nip roll 14, to ensure that the adhesive flows into the anti-block texturing 70 fully and consistently.

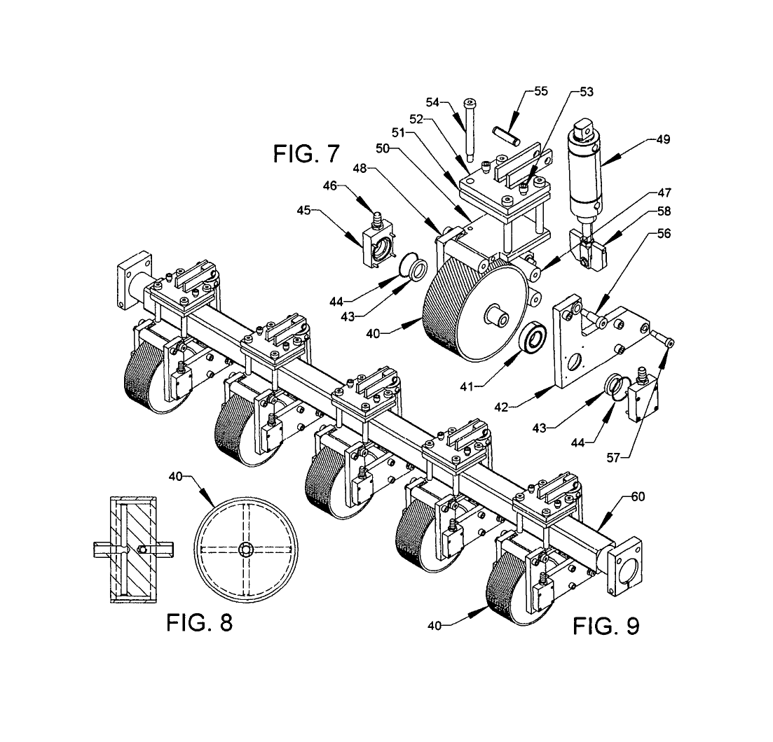

FIG. 7 shows the chilled anti-block texturing wheel 40 that consists of an axle that is supported by ball bearings 41. The axle defines an inlet conduit for conducting coolant into a wheel chamber and an outlet conduit for conducting coolant away from the wheel chamber FIG. 8. A threaded tube fitting 46 is threaded into a fluid cap 45 which attaches to the side plates 42 & 48. An O-ring 44 and shaft seal 43 prevent coolant from leaking the system. The wheel 40 is cooled internally by the coolant, which is preferably cooled and recirculated in a closed loop system. The temperature of the coolant thus controls the temperature of the wheel.

The outer races of the ball bearings 41 are housed in the side plates 42 & 48. The two side plates are held together by standoffs 47. The wheel assembly is allowed to pivot about shoulder bolts 56 which are threaded into the backing plate 50. The pivoting action allows the wheel to create a nip pressure against the web as it moves between the chilled anti-block texturing wheel assembly 40 and nip roller 14 (FIG. 5). The pivoting action also allows the wheel to be retracted from the web when not in use. The air cylinder 49 is attached by a pin 55 to a bracket 52 provides the nip force. The rod of the cylinder is connected to side plates 42 & 48 by shoulder bolts 57 and a clevis bracket 58. The nip pressure applied is adjustable by regulating the air pressure to the cylinder 49.

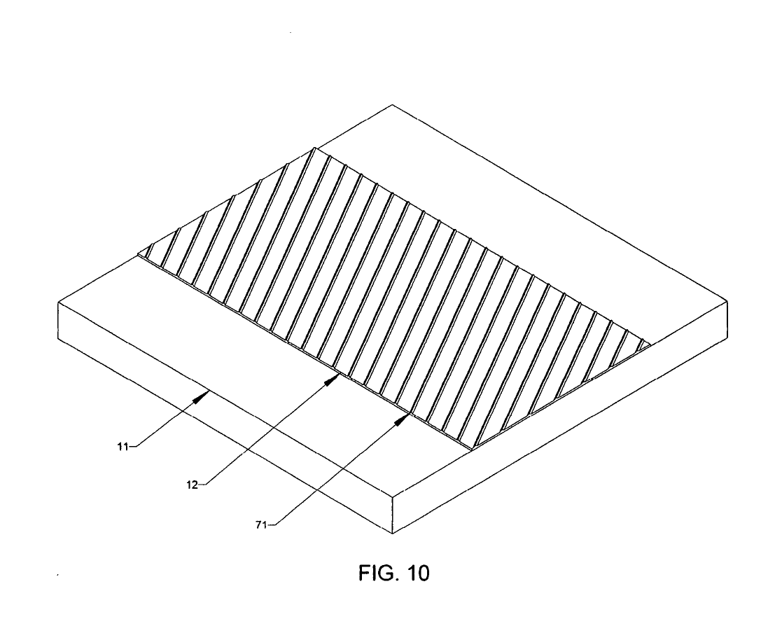

The backing plate 50, shoulder bolts 54, clamping plate 51 and the jacking plate 52 hold the chilled anti-block texturing wheel assembly to the mounting beam 60 (FIG. 9). The position of each wheel assembly can be adjusted over the thermoplastic adhesive coated core material by sliding the assembly along the mounting beam 60. Clamping bolts 53 secure the assembly in the desired position.

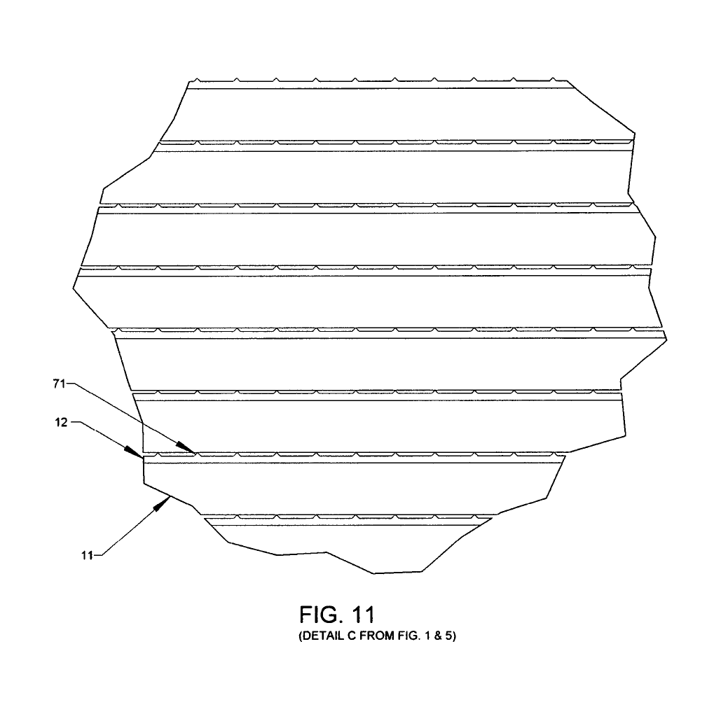

The resulting anti-block texturing formed in the surface of the thermoplastic adhesive coated core material, by this invention, is shown in FIG. 10. The anti-block texturing 70 (FIG. 2 & FIG. 6) in the peripheral surfaces of both the anti-block applicator wheel 20 (FIG. 2) and the chilled anti-block texturing wheel 40 (FIG. 6) produces the anti-block texturing 71 (FIG. 10). The peripheral surface of both the anti-block applicator wheel 20 (FIG. 2) and the chilled anti-block texturing wheel 40 (FIG. 6) contain grooves that preferably spiral at 30° about each respective wheel's axis. The grooves are preferably in the shape of a “V” with the apex having an angle of 90°. The groove depth is preferably 0.0015 inches and spaced 0.012 inches apart (pitch).

FIG. 11 is a magnified view of the sheet stack 17 (FIG. 1 & 5) showing how the surface area of the thermoplastic adhesive coated core material 12 that comes into contact with the opposite side of the substrate 11 is dramatically reduced by the anti-block texturing 71 when compared to the smooth surface produced by a conventional applicator, thus, reducing the blocking tendencies.

What is claimed is:

1. A method for applying an anti-block texture to the surface of a thermoplastic adhesive coated core material as it is applied to a substrate, comprising: an anti-block texturing hot wheel applicator, comprising a cylinder member that rotates about an axis, a guide roll to direct said thermoplastic adhesive coated core material in contact with the peripheral surface of said cylinder member, a means of heating the said cylinder member such that the temperature of the said thermoplastic adhesive coated core material attains the flow point, a means of applying pressure to the outer perimeter of said cylinder member against the surface of the said thermoplastic adhesive coated core material and said substrate, bonding said thermoplastic adhesive coated core material to said substrate, wherein said cylinder member rotates about its axis with movement of said thermoplastic adhesive coated core material and said substrate.

2. An anti-block texturing hot wheel applicator according to claim 1, wherein the peripheral surface of said cylindrical member contains anti-block texturing comprising of a plurality of impressions or grooves spaced around the entire peripheral surface of said cylindrical member.

3. An anti-block texturing hot wheel applicator according to claim 2, where said anti-block texturing is formed into the surface of the applied thermoplastic adhesive coated core material.

4. A method of applying an anti-block texture in the surface of a thermoplastic adhesive coated core material, after it is applied to a moving substrate but before its temperature falls below the flow point comprising; a chilled anti-block texturing wheel, comprising cylindrical member that rotates about an axis, means of applying pressure to the outer perimeter of said cylindrical member against the surface of the said thermoplastic adhesive coated core material wherein, said cylindrical member rotates about its axis with movement of said thermoplastic adhesive coated core material and said substrate, and means of cooling the outer perimeter of said cylindrical member by ducting coolant through internal passages within said cylindrical member.

5. A chilled anti-block texturing wheel according to claim 4, wherein the peripheral surface of said cylindrical member contains anti-block texturing comprising of a plurality of impressions or grooves spaced around the entire peripheral surface of said cylindrical member.

6. A chilled anti-block texturing wheel according to claim 5, wherein said anti-block texturing is formed into the surface of the said thermoplastic adhesive coated core material.
